(19) United States
(12) Patent Application Publication
(10) Pub. No.: US 2004/0137879 A1
(43) Pub. Date: Jul. 15, 2004

(54) Apparatus and method for communicating moving picture mail in a streaming manner

(76) Inventors: Jeong-Wook Seo, Buk-gu (KR); Chae-Whan Lim, Buk-gu (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/745,621

(22) Filed: Dec. 29, 2003

(30) Foreign Application Priority Data
Dec. 28, 2002 (KR) 2002-86056

(51) Int. Cl. H04M 3/16

(52) U.S. Cl. 455/412.1

(57) ABSTRACT

A method and apparatus for enabling a moving picture mail server to transmit moving picture mail to a mobile terminal. When the moving picture mail has arrived, the moving picture mail server notifies the mobile terminal that the moving picture mail has arrived. When the mobile terminal requests that the moving picture mail be transmitted, the moving picture mail is transmitted at a preset transmission rate. Buffering information of the moving picture mail fed from the mobile terminal is checked, and a new transmission rate is set according to a change of the buffering information. The moving picture mail is edited according to the newly set transmission rate, and a transmission operation is performed.

### PRIORITY

This application claims priority to an application entitled “APPARATUS AND METHOD FOR COMMUNICATING MOVING PICTURE MAIL IN STREAMING MANNER”, filed in the Korean Intellectual Property Office on Dec. 28, 2002 and assigned Ser. No. 2002-86056, the contents of which are incorporated herein by reference.

### BACKGROUND OF THE INVENTION

1. Field of the Invention

The present invention relates to an apparatus and method for communicating moving picture mail, and more particularly to an apparatus and method for transmitting moving picture mail from a moving picture mail server to a mobile terminal.

2. Description of the Related Art

Mobile terminals are now capable of transmitting high-speed data as well as voice communication. In particular, mobile communication networks based upon an International Mobile Telecommunication-2000 (IMT-2000) standard can implement high-speed data communications as well as voice communications using mobile terminals. The data for performing the data communications can be packet data and image or picture data.

As the need for moving picture mail from communication carriers and consumers is increasing, services for providing the moving picture mail are being implemented. It is expected that moving picture mail services will increase. Where moving pictures are transmitted, an image compression problem due to a large amount of data can be incurred. Furthermore, when the moving pictures are transmitted or received by means of the mobile terminal, the image compression problem is substantial. Conventionally, moving-picture signal compression is based upon the Moving Picture Expert Group 4 (MPEG 4) standard. When moving picture signals are compressed, an MPEG 4-based compression technique can appropriately compress a large amount of data but requires a large number of million instructions per second (MIPS). Thus, it is difficult for the MPEG 4-based compression technique to be applied to Advanced RISC Machine 7 (ARM 7)-based mobile terminals.

When the above-described image compression method is used, an image can be processed only by software. However, a solution having a high image update rate cannot be used. A mobile terminal equipped with an internal camera or an external camera has a liquid crystal display (LCD) and a codec for compressing image data of still pictures. The codec for compressing the image data of still pictures can be a Joint Photographic Expert Group (JPEG) codec. Camera phones equipped with the above-described components are becoming common when broadband services such as IMT-2000 services are provided. Thus, it is expected that the mobile terminal consecutively compresses moving picture signals through the JPEG codec to generate and display a semi-moving picture signal or transmit the semi-moving picture signal to another mobile terminal or to a moving picture mail server through a network. It is expected that the mobile terminal will be able to receive moving picture signals from another mobile terminal or a moving picture mail server through the network to reproduce the received moving picture signals.

When the moving picture mail or semi-moving picture mail is communicated, a receiving side and a transmitting side determine a transmission rate for the moving picture mail in advance. The transmitting or receiving side transmits or receives the moving picture mail at the determined transmission rate. The channel environment between the transmitting and receiving sides affects a transmission method, such that a cut-off phenomenon in received moving picture signals can occur. If this occurs, the receiving side will request that the transmitting side retransmit the moving picture signal, or will inappropriately reproduce the moving picture signals having the cut-off phenomenon.

### SUMMARY OF THE INVENTION

Therefore, the present invention has been made in view of the above problems, and it is one object of the present invention to provide an apparatus and method that can enable moving picture mail to be communicated between a moving picture mail server and a mobile terminal in a mobile communication network.

It is another object of the present invention to provide an apparatus and method that can enable a mobile communication network to transmit moving picture mail from a moving picture mail server to a mobile terminal in a streaming manner.

It is another object of the present invention to provide an apparatus and method that can enable a mobile terminal provided in a mobile communication network to receive moving picture mail from a moving picture mail server in a streaming manner.

It is another object of the present invention to provide an apparatus and method that can enable a moving picture mail server to transmit moving picture mail to a mobile terminal and vary a transmission rate of the moving picture mail according to reception state information transmitted from the mobile terminal.

It is yet another object of the present invention to provide an apparatus and method that can enable a mobile terminal to receive and reproduce moving picture mail transmitted from a moving picture mail server, and enable the mobile terminal to transmit reception state information to the moving picture mail server so that the moving picture mail server can determine a transmission rate of the moving picture mail based upon the reception state information in order to vary the transmission rate.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating the architecture of a network for transmitting moving picture mail in accordance with an embodiment of the present invention;

FIG. 2 is an block diagram illustrating a communication procedure between a moving picture mail server and a mobile terminal shown in FIG. 1;

FIGS. 3A and 3B are block diagrams illustrating the formats of moving picture signals in accordance with an embodiment of the present invention;

FIGS. 4A through 4E are block diagram illustrating the formats of packets for transmitting moving picture mail in accordance with an embodiment of the present invention;

FIG. 5 is a flow chart illustrating a procedure for enabling the moving picture mail server to transmit the moving picture mail in accordance with an embodiment of the present invention;

FIG. 6 is a block diagram illustrating an example of varying a transmission rate of the moving picture mail transmitted from the moving picture mail server;

FIG. 7 is a flow chart illustrating a procedure for enabling the mobile terminal to receive the moving picture mail and enabling reception state information of the moving picture mail to be transmitted to the moving picture mail server in accordance with an embodiment of the present invention;

FIG. 8 is a block diagram illustrating the format of a reception state message associated with the moving picture mail described in FIG. 7;

FIG. 9 is a block diagram illustrating components for enabling the mobile terminal to receive and reproduce moving picture mail in accordance with an embodiment of the present invention; and

FIG. 10 is a block diagram illustrating components for receiving and reproducing packets of moving picture mail in the mobile terminal shown in FIG. 9.

### DETAILED DESCRIPTION OF THE PREFERRED EMBODIMENT

An embodiment of the present invention will be described in detail with reference to the accompanying drawings. In the drawings, the same or similar elements are denoted by the same reference numerals.

In the following description, specified details relating to the format of a moving picture signal, the format of a packet to be transmitted, an image compression technique, the transmission rate of moving picture mail, etc. are provided as examples. It will be obvious to those skilled in the art that the present invention can be implemented with various modifications without using the described examples.

In an embodiment of the present invention, it is assumed that a moving picture signal includes a moving picture and a semi-moving picture signal. Furthermore, the moving picture signal can be a combined signal in which image signals are combined with other signals in accordance with the embodiment of the present invention. In accordance with the embodiment of the present invention, the moving picture signal can be a combined signal in which image signals are combined with audio signals, a text signal or audio and text signals. Hereinafter, it is assumed that the expression “moving picture signal” or “moving picture mail” is a combined signal in which image signals are combined with audio signals. It is assumed that the moving picture signal is the semi-moving picture signal.

It is assumed that a Joint Photographic Expert Group (JPEG) coding technique is employed as an image signal coding technique in accordance with the embodiment of the present invention. Alternatively, another image coding technique can be employed in the embodiment of the present invention. In accordance with the embodiment of the present invention, received moving picture signals are coded at predetermined time intervals by means of the JPEG coding technique as the still-picture signal coding technique so that coded image data can be generated.

It is assumed that a portable or mobile terminal for processing moving picture signals is a mobile phone in accordance with the embodiment of the present invention. The portable or mobile terminal in accordance with the embodiment of the present invention can include all mobile communication devices other than the mobile phone. For example, the mobile communication device can be a Personal Digital Assistant (PDA).

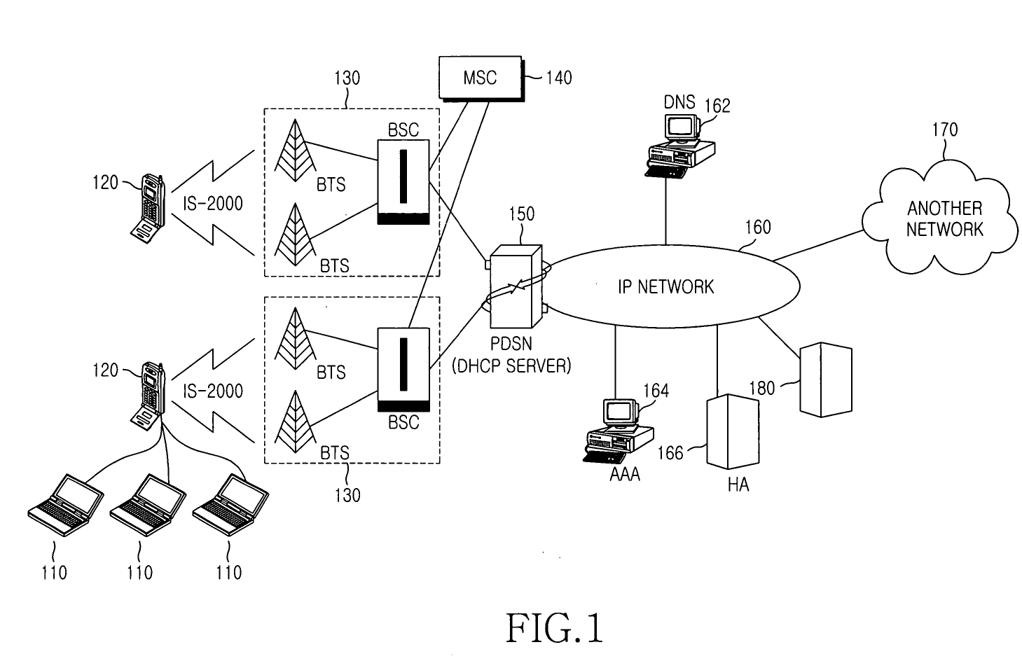

FIG. 1 is a block diagram illustrating the architecture of a network including a mobile communication system capable of transmitting moving picture mail in accordance with an embodiment of the present invention. The mobile communication system network can be based upon a code division multiple access Code Division Multiple Access (CDMA) 2000 system. A user terminal can be a portable or mobile computer in FIG. 1.

Referring to FIG. 1, a portable or mobile terminal 120 can be connected to one or more user terminals 110. The mobile terminal 120 is connected to at least one base station (BS) 130 and at least one radio channel based upon a CDMA 2000 standard so that a call service can be provided. Conventionally, the BS 130 includes a base transceiver subsystem (BTS) and a base station controller (BSC). A mobile switching center (MSC) 140 connects the BS 130 to another subscriber system of a public switched telephone network (PSTN) (not shown) or etc. through a path (not shown) so that the call service based on a telephone circuit can be provided to the mobile terminal 120. A plurality of BSs 130 and the MSC 140 form a radio communication network based upon the CDMA 2000 standard.

The BSs 130 are connected to a data core network, i.e., an Internet protocol (IP) network 160, through a packet data service node (PDSN) 150. Here, the PDSN 150 serves as a gateway for interconnecting the IP network 160 and another network. In particular, the PDSN 150 connected to a wireless communication network can include the MSC 140 according to the advanced network architecture.

The PDSN 150 provides a packet service to mobile terminals 120 through a CDMA-based wireless communication network. When the mobile terminal 120 performs a relay function between the PDSN 140 and the user terminal 110, the PDSN 150 sets up a point-to-point protocol (PPP) link with the user terminal 110, and then assigns an IP address to the user terminal 110 to enable the user terminal 110 to access the Internet.

Furthermore, the IP network 160 is connected to another network 170 including a plurality of Internet service providers and nodes, and then provides a packet data service to the mobile terminals 120. The IP network 160 is connected to a plurality of network elements, i.e., a domain name server (DNS) 162, an authentication, authorization and accounting (AAA) server 164, a home agent (HA) 166, a moving picture mail server 180, etc. When moving picture mail arrives, the moving picture mail server 180 notifies the mobile terminals 120 of the moving-picture mail's arrival, and transmits the moving picture mail to the mobile terminals 120 in a streaming manner.

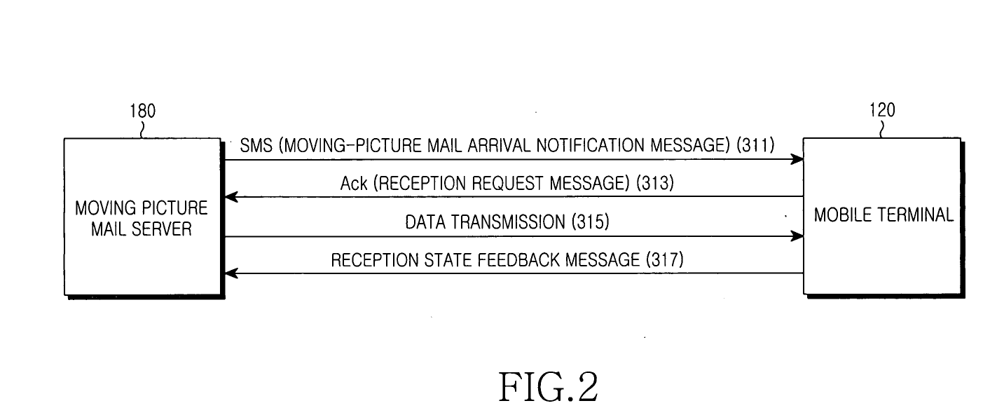

FIG. 2 is a block diagram illustrating a communication procedure between the moving picture mail server and the mobile terminal shown in FIG. 1.

Referring to FIG. 2, when moving picture mail to be transmitted to the mobile terminal 120 is present, the moving picture mail server 180 generates a moving-picture mail arrival notification message and transmits the generated moving-picture mail arrival notification message to the mobile terminal 120 at step 311. In response to the moving-picture mail arrival notification message, the mobile terminal 120 generates a reception request message and then transmits the generated reception request message to the moving picture mail server 180 at step 313. Upon receiving the reception request message, the moving picture mail server 180 begins to transmit data of the moving picture mail at a preset transmission rate at step 315.

The mobile terminal 120 must include a minimum buffer space required for receiving the moving picture mail and enabling the received moving picture mail to be displayed in real time. For example, where the moving picture mail server 180 transmits image and audio signals corresponding to 5 frames per second according to a standard of moving picture mail, the mobile terminal 120 must include a buffer capable of buffering moving picture mail data of 5 seconds or more. Furthermore, when the buffer is full, the mobile terminal 120 performs an operation for accessing and reproducing moving pictures stored in the buffer and an operation for receiving and storing moving picture mail transmitted from the moving picture mail server 180, simultaneously.

If the operation of reproducing and receiving the moving picture mail is performed, the mobile terminal 120 checks buffering depth indicating an amount of data accumulated in the buffer at a predetermined time interval, determines the state of a communication network according to a result of the check, and notifies the moving picture mail server 180 of the result of the determination. That is, the mobile terminal 120 generates a reception state message indicating the communication network state at a predetermined time interval and then transmits the generated reception state message to the moving picture mail server 180 at step 317. Furthermore, the moving picture mail server 180 varies a transmission rate of moving picture mail according to a current environment of the communication network in response to the reception state message and performs a transmission operation at the varied transmission rate at step 315. In a method for varying the transmission rate, a decimation operation for an image frame is performed, or the size of an image frame or the number of pixels is reduced.

In accordance with the embodiment of the present invention, the moving picture mail server 180 transmits moving picture mail to the mobile terminal 120 in a streaming manner. The moving picture mail server 180 adjusts an amount of data to be transmitted on the basis of a preset method in response to reception state information transmitted from the mobile terminal 120 at a predetermined time interval. This operation is performed in order to compensate for a cut-off phenomenon of a moving picture signal to be reproduced. Furthermore, because the mobile terminal 120 must reproduce the moving picture mail transmitted from the moving picture mail server 180 in real time, an operation for reproducing data of the moving picture mail transmitted from the moving picture mail server 180 and receiving other data of the moving picture mail are simultaneously performed when the amount of received data of the moving picture mail has reached a predetermined size or more. At this point, a packet of the transmitted moving picture mail uses a user datagram protocol (UDP) in place of a transmission control protocol (TCP). However, where the UDP is used, packet loss can occur depending on the state of the network. This packet loss can adversely affect a moving picture signal based upon Joint Photographic Expert Group (JPEG) data. For this reason, the embodiment of the present invention can minimize packet loss using the TCP.

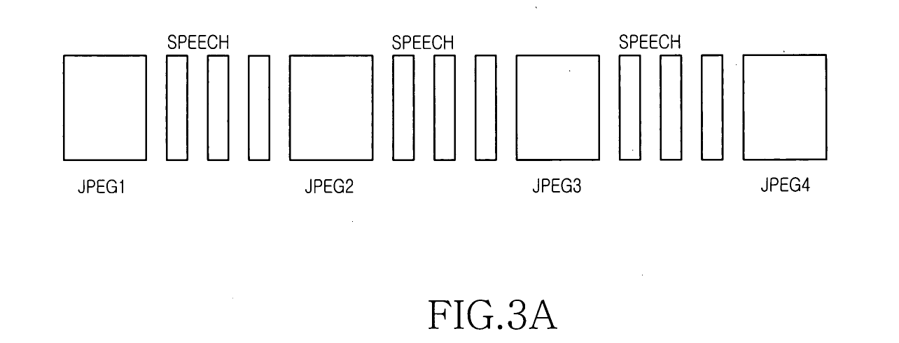

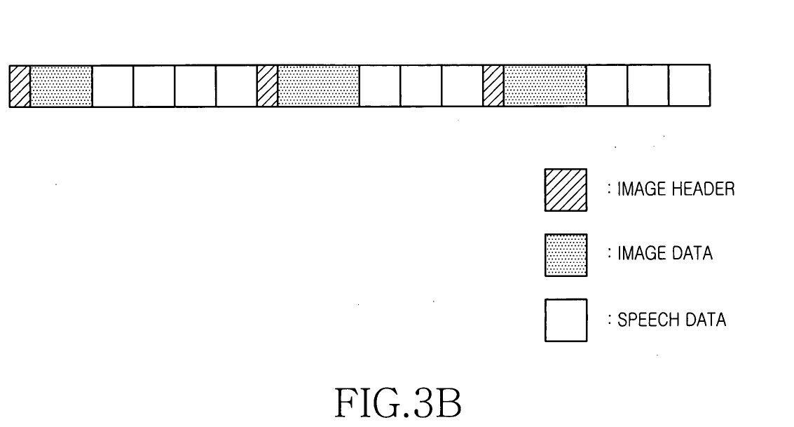

In accordance with the embodiment of the present invention, it is assumed that the moving picture mail includes consecutive still picture signals JPEG1, JPEG2 and others and audio signals, and the audio signals are interlaced between the still picture signals JPEG1, JPEG2 and others as shown in FIG. 3A. That is, it is assumed that the moving picture mail as the semi-moving picture signal has a format in which the audio signals are inserted between the still picture signals. Therefore, the still picture signal is an image screen signal of one frame. An image header containing “L” indicating a size of a corresponding frame and a pattern signal “P” indicating the existence of an image is inserted into the still picture signal. The moving picture mail can have a format in which the image headers, the JPEG coded image signals and the audio signals are combined as shown in FIG. 3B.

When the moving picture mail is transmitted, the moving picture mail server 180 generates transmission packets of the moving picture mail and transmits the generated packets.

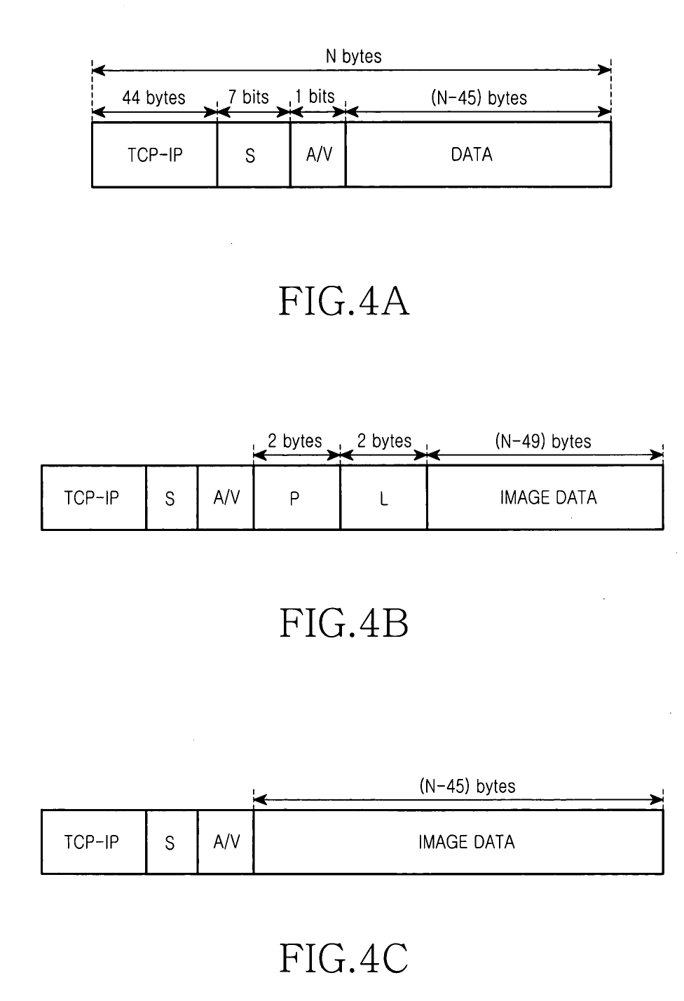

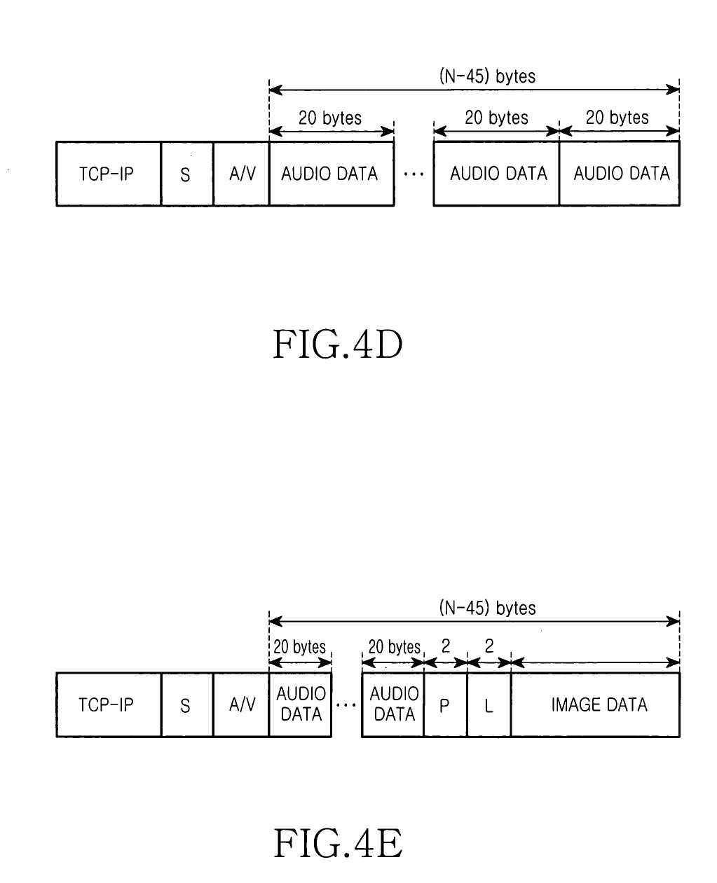

FIGS. 4A through 4E are block diagrams illustrating the formats of packets for transmitting the moving picture mail in accordance with an embodiment of the present invention.

FIG. 4A shows the format of a packet to be transmitted from the moving picture mail server 180. A total size N of the packet to be transmitted can be selectively determined, and the total size N can be set within the range of approximately 200 to 1500 bytes. The size of a packet to be transmitted must be constant in every packet. Referring to the packet format, a TCP/IP header of 44 bytes and a sequence number S of 7 bits can be included within the packet. The sequence number S indicates a sequence of generated packets. The sequence number may have one of a value 0 to a value 127. After the sequence number of the value 127, the sequence number of the value 0 is newly selected. A 1-bit A/V value subsequent to the sequence number S indicates whether the first data of a corresponding packet is audio or JPEG image data.

FIGS. 4B and 4C show packets of JPEG image data formats. In the case of the JPEG image data, the size of one frame is set within the range of 5 to 10 Kbytes. The image data length of one frame is longer than that of data of one packet. Thus, the JPEG image data of one frame must be transmitted through a plurality of packets. The first packet of the frame image data includes P and L values of the image header as shown in FIG. 4B. In FIG. 4B, the P value indicates a pattern signal used for discriminating between audio data and JPEG image data in a receiver receiving packet data, and its image header information. In FIG. 4B, the L value indicates the total size of a JPEG image frame. The mobile terminal 120 detects a JPEG image through the pattern signal P from the transmitted packet shown in FIG. 4B, and reads JPEG image data corresponding to the L value. When the received and buffered data corresponds to the L value while the mobile terminal 120 consecutively receives and buffers data, the received and buffered JPEG image data is applied to an image codec 80 so that it can be decoded and reproduced. FIG. 4C shows the remaining packet format after the first packet of JPEG image data of one frame is transmitted. The remaining packet can be filled with JPEG image data without an image header.

FIG. 4D shows the format of an audio signal packet. In the embodiment of the present invention, it is assumed that an audio codec 85 is an 8 Kbps speech codec. Where the audio codec 85 is the 8 Kbps speech codec, coded audio data of one frame (20 bytes) is generated every 20 msec. At this time, until N −45 bytes corresponding to the maximum size of data are assembled in one packet, a plurality of coded audio frame data units are consecutively coupled to one another so that an audio packet can be generated. For example, where N is 200, a plurality of audio data units corresponding to 17 frames and a ¾ frame (15 bytes) are assembled, such that one packet can be generated. Since the JPEG image data is typically inserted between the audio frames, a format in which audio data and JPEG image data are mixed is generated as shown in FIG. 4E.

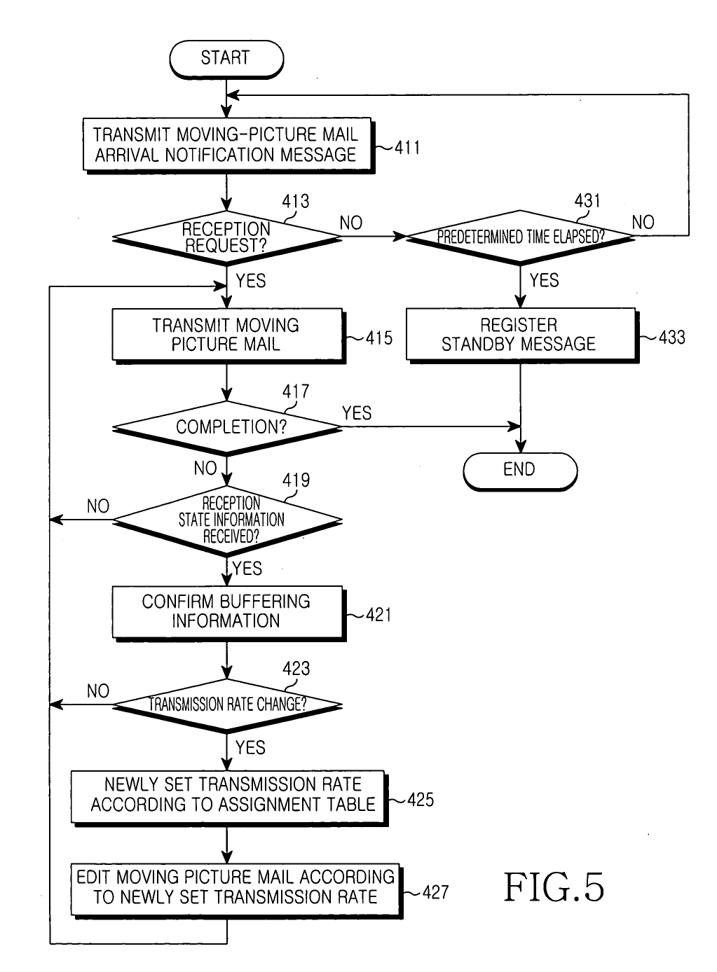

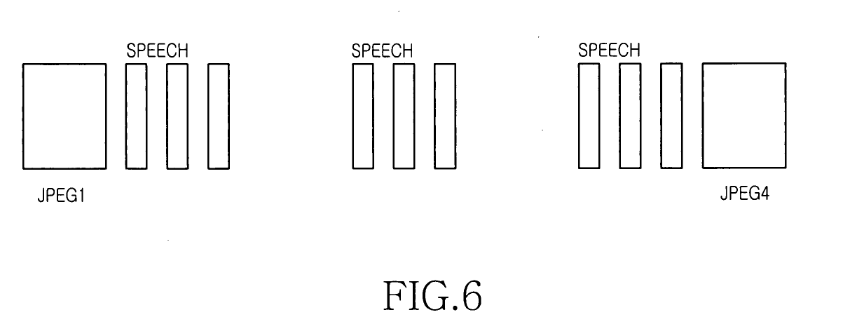

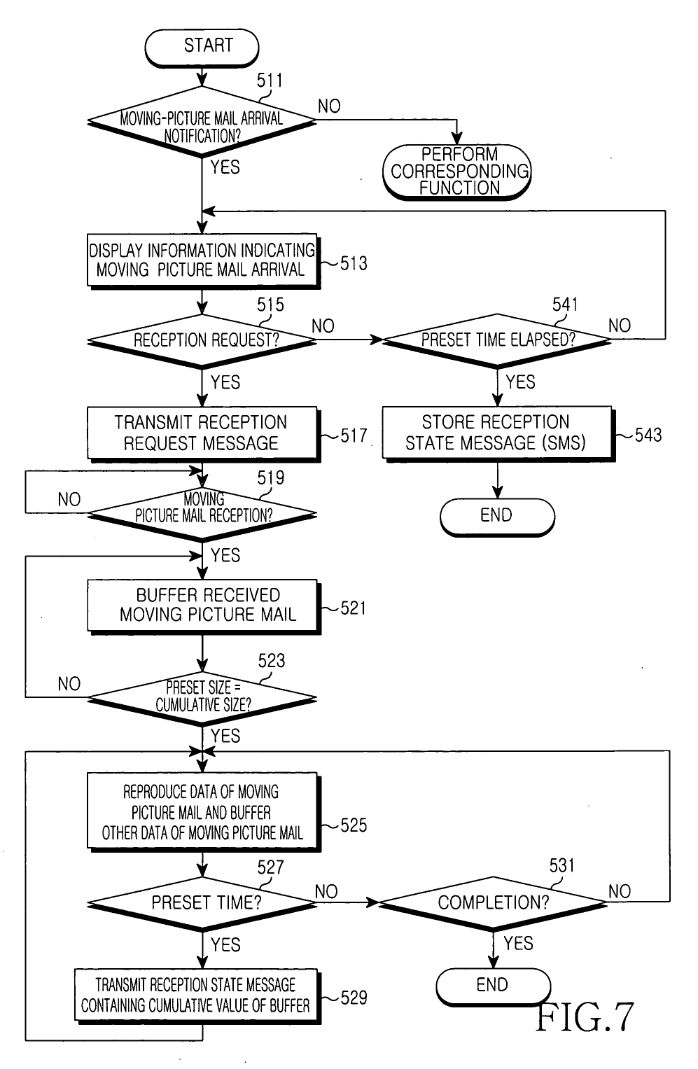

FIG. 5 is a flow chart illustrating a procedure for enabling the moving picture mail server to transmit the moving picture mail in accordance with an embodiment of the present invention; and FIG. 6 is a block diagram illustrating an example of varying a transmission rate of the moving picture mail transmitted from the moving picture mail server.

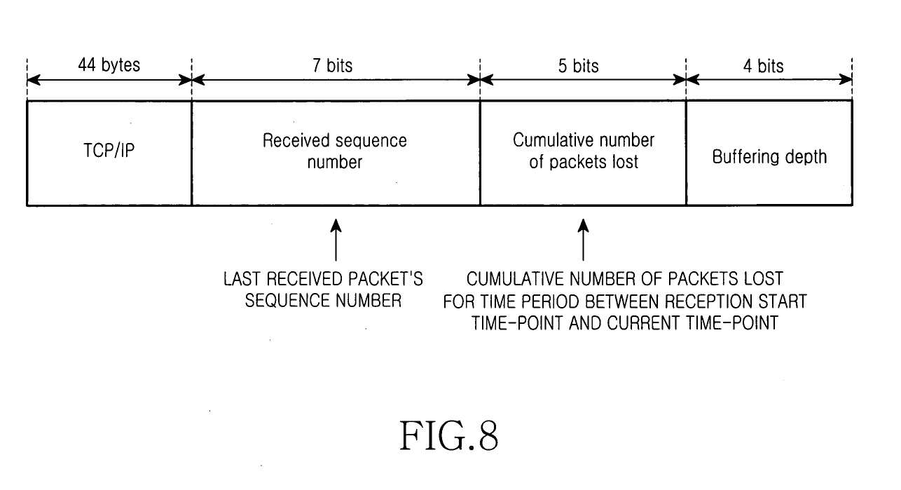

FIG. 7 is a flow chart illustrating a procedure for enabling a mobile terminal to receive the moving picture mail and enabling reception state information of the moving picture mail to be transmitted to the moving picture mail server in accordance with an embodiment of the present invention; and FIG. 8 is a block diagram illustrating the format of a reception state message associated with the moving picture mail described in FIG. 7.

An operation for enabling the moving picture mail server 180 to transmit the moving picture mail and an operation for enabling the mobile terminal 120 to receive the moving picture mail will be described with reference to FIGS. 5 through 8.

First, when the moving picture mail to be transmitted to the mobile terminal 120 is present, the moving picture mail server 180 transmits, to the mobile terminal 120, a message indicating that the moving picture mail has arrived at step 411 shown in FIG. 5. Then, the moving picture mail server 180 determines, at step 413, whether a reception request message has been received from the mobile terminal 120. At this point, if the reception request message has not been received, the moving picture mail server 180 waits for a predetermined time to elapse as shown in step 431 and repeats at step 411. If the reception request message is not received by the time that the predetermined time elapses, a standby message is registered at step 433 and the operation ends. That is, after notifying a corresponding mobile terminal that the moving picture mail has arrived, the moving picture mail server 180 waits to receive the reception request message from the corresponding mobile terminal during the predetermined time. Hence, if the reception request message is not received during the predetermined time, the standby message is registered at the above step 433 and the operation ends. After the predetermined time has elapsed, the moving picture mail server 180 analyzes the standby message and repeatedly performs the above-described operations. If the reception request message has been received within the predetermined time, the moving picture mail server 180 proceeds to step 415 a determination is made to transmit the moving picture mail. If the moving picture has been transmitted at step 417, the operation ends. If the moving picture has not been transmitted at step 417, the operation proceeds to step 419, which is described later.

Upon receiving a moving-picture mail arrival notification message, the mobile terminal 120 detects the moving-picture mail notification message at step 511 shown in FIG. 7, and displays information indicating the moving picture mail arrival at step 513. Then, when a reception request command for the moving picture mail is generated from a user, the mobile terminal 120 detects the reception request command at step 515 and generates a reception request message for the moving picture mail to transmit the generated reception request message for the moving picture mail at step 517. Then, the mobile terminal 120 waits to receive the moving picture mail. If the user of the mobile terminal 120 does not generate the reception request command at step 515, the mobile terminal 120 proceeds to step 541 and waits for a predetermined time. At this time, if the reception request command is not generated after the predetermined time, the mobile terminal 120 stores the moving-picture mail arrival notification message as a received message at step 543 and the operation ends. If the user generates the reception request message after confirming the received message, the operation for receiving the moving picture mail is performed.

In response to the reception request message, the moving picture mail server 180 begins to transmit the moving picture mail at a transmission rate set by the mobile terminal 120 at the above step 415 shown in FIG. 5. The transmission operation is continuously performed at the set transmission rate until a reception state message is received from the mobile terminal 120.

Then, the mobile terminal 120 detects the received moving picture mail at step 519 shown in FIG. 7, and stores the received moving picture mail in a buffer at step 521. At this time, the buffer must have a buffer size necessary for buffering an amount of data capable of being reproduced during a predetermined time or more. In the embodiment of the present invention, the transmission rate corresponds to 5 frames per second. It is assumed that the buffer of the mobile terminal 120 has a buffer size necessary for reproducing moving picture mail data of 5 seconds or more. Assuming that a size of image and audio signals corresponding to one frame is 5 Kbytes, the buffer must have a size of 125 Kbytes or more. In the embodiment of the present invention, it is assumed that the buffer has a size of more than 125 Kbytes.

When the mobile terminal 120 accumulates and stores the received moving picture mail at step 521 and a predetermined size (i.e., 125 Kbytes) of moving picture mail stored in the buffer has been received, the mobile terminal 120 recognizes the fact that the received moving picture mail stored in the buffer has reached the predetermined size (i.e., 125 Kbytes) at step 523 and accesses the moving picture mail stored in the buffer to display the moving picture mail on a display unit at step 525. The mobile terminal 120 continuously performs an operation for buffering other data of the moving picture mail transmitted from the moving picture mail server 180.

The mobile terminal 120 checks an amount of data accumulated in the buffer at a preset time interval, and generates a message based upon the state of a communication network. If a preset time has elapsed, the mobile terminal 120 recognizes that the preset time has elapsed at step 527, and checks an amount of data accumulated in the buffer and generates a reception state message to transmit the generated reception state message to the moving picture mail server 180 at step 529. If the preset time has not elapsed, the mobile terminal 120 checks if the reproduction and buffering is completed. If not, the processing returns to step 525 and the above operations are completed. If the operations are completed, the reproduction and buffering ends. The reception state message has a format shown in FIG. 8. The format of the reception state message contains a TCP/IP header, a received sequence number, the cumulative number of packets lost, buffering information indicating buffering depth, etc. The buffering information indicates an amount of data accumulated in the buffer and can be decided on the basis of the following Table 1. A range of an “x” value contained in the following Table 1 can be varied according to a request from a communication carrier after characteristics of the communication network are analyzed before the service is initiated. The buffering information is used as information for determining a transmission rate of the moving picture mail in the moving picture mail server 180, and is included in the reception state message shown in FIG. 8 so that the buffering information included in the reception state message can be transmitted to the moving picture mail server 180.

TABLE 1

| Amount of data accumulated in | |
|---|---|
| buffer | Buffering depth |
| (x: Kbytes) | (Bits) |
| 125 ≦ x | 0110 |
| 100 ≦ x < 125 | 0101 |
| 75 ≦ x < 100 | 0100 |
| 50 ≦ x < 75 | 0011 |
| 25 ≦ x < 50 | 0010 |
| 10 ≦ x < 25 | 0001 |
| x < 10 | 0000 |

When the mobile terminal 120 transmits the reception state message shown in FIG. 8, the moving picture mail server 180 recognizes the reception state message at step 419 shown in FIG. 5, analyzes the buffering information contained in the reception state message at step 421 and determines whether a transmission rate must be changed on the basis of a result of the analysis. At this time, if the buffering information has not been changed, the moving picture mail server 180 recognizes the fact that the buffering information has not been changed at step 423 and returns to step 415 so that the moving picture mail can be transmitted at the previous transmission rate. On the other hand, if the moving picture mail server 180 recognizes the fact that the buffering information has been changed at step 423, the moving picture mail server 180 newly sets the transmission rate on the basis of a transmission rate assignment table at step 425 and then edits the moving picture mail according to the newly set transmission rate to transmit the edited moving picture mail at step 427.

TABLE 2

| Buffering depth | Transmission rate |
|---|---|
| (Bits) | (Frames per sec) |
| 0110 | Max |
| 0101 | 5 |
| 0100 | 4 |
| 0011 | 3 |
| 0010 | 2 |
| 0001 | 1 |
| 0000 | 0 |

Table 2 shows an example of the transmission rate assignment table. The moving picture mail server 180 includes the transmission rate assignment table such as Table 2 and can adjust the transmission rate indicating the number of frames per second. In Table 2, it is assumed that the number of frames per second is “5” in a normal environment, and its buffering information indicates “0101”. Furthermore, when the buffering information of the reception state message is “0011”, the number of frames per second to be transmitted is set to “3”. An editing operation is performed so that all audio signals contained in the moving picture mail can be transmitted. FIG. 6 shows an example of moving picture mail edited and transmitted according to a newly set transmission rate.

The mobile terminal 120 repeatedly checks an amount of data accumulated in the buffer every preset time and transmits the reception state message shown in FIG. 8. In response to the reception state message, the moving picture mail server 180 adjusts the transmission rate of moving picture mail to be transmitted on the basis of the format shown in FIG. 6 and then transmits the moving picture mail at the adjusted transmission rate.

The above-described operations are repeatedly performed until the moving picture mail server 180 terminates a transmission operation for the moving picture mail.

In accordance with the embodiment of the present invention, FIG. 6 shows an example of performing a decimation and transmission operation for an image frame. That is, because the moving picture mail must be reproduced in real time, the transmission time must be fixed and information of the moving picture mail must be varied, when the transmission rate is varied. A method for varying the information of the moving picture mail includes a method for performing the decimation operation for the image frame as shown in FIG. 6 and transmitting a result of the decimation operation, a method for reducing a size of the image frame and transmitting the reduced image frame, a method for reducing the number of image frame pixels and transmitting the reduced image frame pixels, etc.

The embodiment of the present invention considers a case when a transmission rate is lowered according to a channel environment. When the moving picture mail is transmitted in the better channel environment, it is assumed that the moving picture mail server 180 does not vary the current transmission rate and maintains the current transmission rate at it is. On the other hand, when the transmission rate is better, the moving picture mail server 180 can consecutively transmit the moving picture mail.

A moving picture mail communication procedure in the mobile terminal 120 will be described.

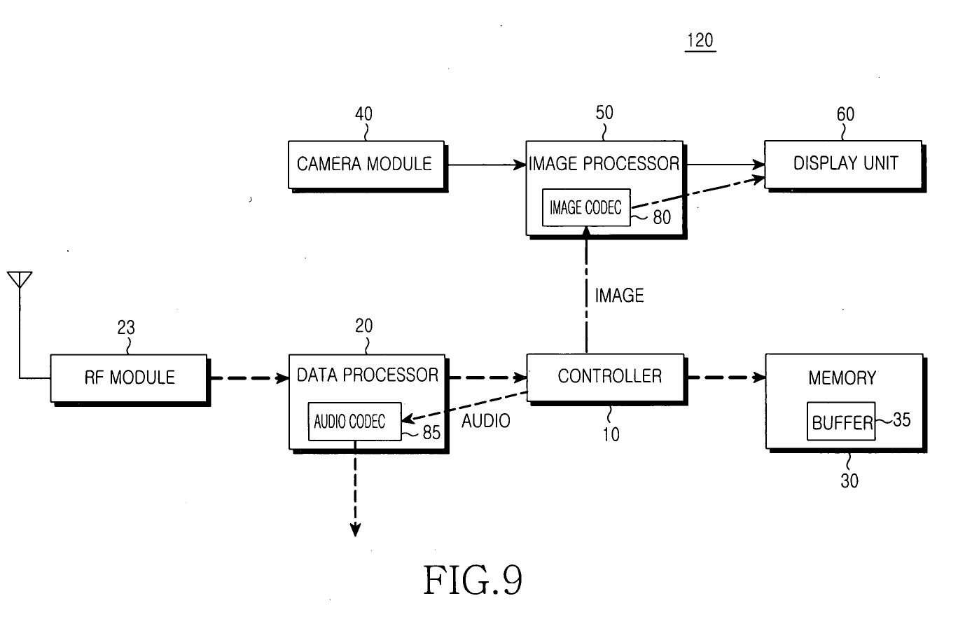

FIG. 9 is a block diagram illustrating components for receiving and reproducing the moving picture mail in the mobile terminal 120 equipped with a camera and an image codec in accordance with the embodiment of the present invention. In a moving picture reception method, the moving picture mail received from the moving picture mail server 180 is stored in a memory 30 or can be displayed in real time. The memory 30 includes a buffer 35 for buffering the moving picture mail in accordance with the embodiment of the present invention.

First, an operation for buffering the received moving picture mail in the buffer 35 will be described. A radio frequency (RF) module 23 converts a radio signal of the received moving picture mail into a baseband signal. A data processor 20 performs a channel demodulation and decoding operation for the received moving picture mail and transmits a result of the channel demodulation and decoding operation to a controller 10. The controller 10 enables the received moving picture mail to be stored in the buffer 35 assigned to the memory 30. Then, when an amount of data accumulated in the buffer 35 exceeds a preset size, the controller 10 accesses the moving picture mail stored in the buffer 35 and separates audio data and JPEG coded image data from the moving picture mail. The controller 10 transmits the JPEG coded image data to an image codec 80 and transmits the audio data to an audio codec 85. The image codec 80 decodes the JPEG coded image data into original image data, and an image processor 50 adjusts a size of the original image data on the basis of a size of a display unit 60 and outputs the adjusted image data to the display unit 60. The display unit 60 of the mobile terminal 120 displays image data of the received moving picture mail. The audio data decoded by the audio codec 85 is reproduced through a speaker (not shown).

The controller 10 checks an amount of data accumulated in the buffer 35 every preset time and decides buffering information. The controller 10 generates a reception state message containing the buffering information and then transmits the generated reception state message to the moving picture mail server 180. Then, the mobile terminal 120 receives moving picture mail at an adjusted transmission rate and repeatedly performs the described operations.

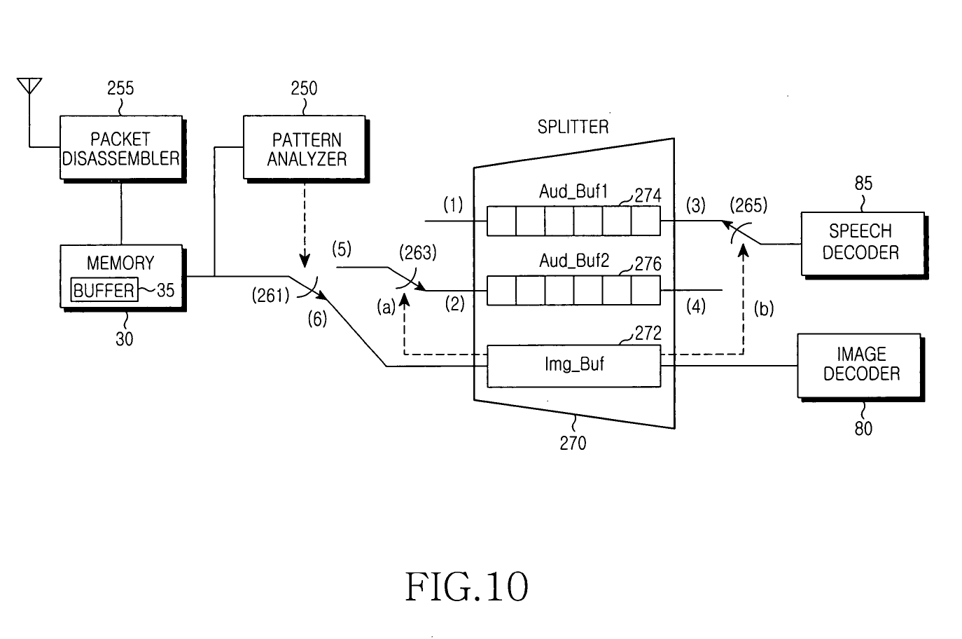

FIG. 10 is a block diagram illustrating components for receiving and reproducing packets of moving picture mail in the mobile terminal shown in FIG. 9. A packet disassembler 255, a header analyzer 250, switches 261, 263 and 265 and a buffer unit 270 shown in FIG. 10 can comprise the controller 10.

The components shown in FIG. 10 will now be described. Packet data transmitted from the moving picture mail server 180 is processed through the RF module 23 and the data processor 20. The packet disassembler 255 receives the processed packet data. Received packets have the formats shown in FIGS. 4A through 4E. The packet disassembler 255 removes a TCP/IP header from a received packet. The packet disassembler 255 can sequentially process the packets according to sequence numbers of the received packets. An audio packet or a JPEG image packet can be discriminated by an A/V bit. Thus, the packet disassembler 255 can disassemble the received packets according to the format shown in FIG. 3A.

The buffer 35 of the memory 30 stores the moving picture mail shown in FIG. 3B that is output from the packet disassembler 255. When the moving picture mail of a preset size or more is stored in the buffer 35, the controller 10 controls the buffer 35 so that the moving picture mail can be output. The header analyzer 250 analyzes the moving picture mail output from the buffer 35 and generates a switch control signal necessary for separating JPEG image data and audio data from the moving picture mail. A common terminal is connected between the switch 261 and the memory 30. The first output terminal of the switch 261 is connected to a common terminal for the switch 263 switching the audio signals, and the second output terminal of the switch 261 is connected to an image buffer 272. The image buffer (Img_Buf) 272 provided in the buffer unit 270 buffers JPEG image data output from the switch 261. The first and second audio buffers (Aud_Buf1 and Aud_Buf2) 274 and 276 buffer coded audio data. The common terminal for the switch 263 is connected to the first output terminal of the switch 261. The first output terminal of the switch 263 is connected to an input terminal of the first audio buffer 274, and the second output terminal of the switch 263 is connected to an input terminal of the second audio buffer 276. Furthermore, the first input terminal of the switch or speech output switch 265 is connected to an output terminal of the first audio buffer 274 and the second input terminal of the switch 265 is connected to an output terminal of the second audio buffer 276. A common terminal is connected between the switch 265 and the audio codec (or speech decoder) 85. The switches 263 and 265 are controlled by an output of the image buffer 272. Thus, the buffer unit 270 performs a splitter function for splitting audio signals and JPEG image signals from the moving picture mail. The audio codec (or speech decoder) 85 decodes coded audio signals output from the switch 265 and outputs the decoded audio signals. The image codec (or image decoder) 80 decodes JPEG image data output from the image buffer 272 and outputs the decoded image data.

Referring to FIG. 10, the packet disassembler 255 removes TCP/IP headers from the received packets. The received packets are stored in the buffer 35 of the memory 30. When the moving picture mail of a preset size or more is stored in the buffer 35, the controller 10 accesses the moving picture mail stored in the buffer 35 and then outputs the accessed moving picture mail. Then, the packet analyzer 250 generates a switch control signal necessary for separating the moving picture mail output from the buffer 35. TCP/IP headers of the moving picture mail consecutively transmitted from the moving picture mail server 180 are removed by the packet disassembler 255 and the moving picture mail is stored in the buffer 35.

At this time, an operation for separating JPEG image data and audio data from the moving picture mail in the header analyzer 250 will be described below.

At the 1st step, the first packet (20 bytes) of the received packets is read. At the 2nd step, an operation for masking the first 2 bytes of the 20 bytes with “0×FFFF” is performed. If a masking value is “0×0000” at the 3rd step, the 4th step is performed. On the other hand, if a masking value is another value other than “0×0000”, the following 10th step discussed below is performed.

At the 4th step, a current packet is determined to be JPEG image data, and the header analyzer 250 enables the switch or A/V switch 261 to be switched to a point (6) as shown in FIG. 10. Then, at the 5th step, the next 2 bytes having an L value indicating a total size of JPEG image data in the 20 bytes is read. At the 6th step, a switch or speech input switch 263 is switched to a point (1). At the 7th step, a size of input data is continuously counted and data input by the total size read at the 5th step is continuously stored in the image buffer (Img_Buf) 272. At the 8th step, if a count value as a result of the counting performed at the 7th step is equal to the total size read at the 5th step, the switch 261 is switched to the point (5). Input data is read in units of 20 bytes at the 9th step and the 2nd step is performed.

At the 10th step, received audio data is stored in the first audio buffer (Aud_Buf1) 274. At the 11th step, the JPEG image data stored in the image buffer 272 is transmitted to the image codec (or image decoder) 80, the switch or speech output switch 265 is switched to the point (3), and switch 263 is switched to a point (2). The audio data stored in the first audio buffer 274 is transmitted to the audio codec (or audio decoder) 85, and received audio data is stored in the second audio buffer 276. When the audio data is stored in the second audio buffer 276, the switch 265 is switched to a point (4) and the switch 263 is switched to the point (1).

At the 12th step, if JPEG image data to be processed by the image codec 80 remains, the remaining JPEG image data is discarded as it is determined that the image codec 80 can no longer perform a processing operation. Then, the operation returns to the 9th step. At this point, the switches 263 and 265 are switched to points different from the previous points.

At this point, the controller 10 checks a size of moving picture mail accumulated in the buffer 35 at a predetermined time interval, and decides buffering information according to a result of the check. Then, the controller 10 generates the reception state message shown in FIG. 8 containing the decided buffering information and then transmits the reception state message to the moving picture mail server 180. Then, the moving picture mail server 180 confirms the buffering information contained in the reception state message and determines a state of the communication network. According to a result of the determination, the moving picture mail server 180 changes a transmission rate and transmits the moving picture mail at the changed transmission rate.

As apparent from the above description, the present invention provides an apparatus and method that can enable a moving picture mail server to transmit moving picture mail to a mobile terminal in a streaming manner, enable the moving picture mail server to adjust an amount of data to be transmitted on the basis of a preset method in response to reception state information transmitted from the mobile terminal at a predetermined time interval, such that a cut-off phenomenon of a moving picture signal to be reproduced in the mobile terminal can be compensated for.

Although the embodiments of the present invention have been disclosed for illustrative purposes, those skilled in the art will appreciate that various modifications, additions and substitutions are possible, without departing from the scope of the invention.

What is claimed is:

1. A method for enabling a moving picture mail server to transmit moving picture mail to a mobile terminal, comprising the steps of:
(a) when the moving picture mail has arrived, allowing the moving picture mail server to notify the mobile terminal that the moving picture mail has arrived;
(b) when the mobile terminal requests that the moving picture mail be transmitted, transmitting the moving picture mail at a preset transmission rate; and
(c) checking buffering information of the moving picture mail provided from the mobile terminal, setting a new transmission rate according to a change of the buffering information, editing the moving picture mail according to the newly set transmission rate, and performing a transmission operation.

2. The method as set forth in claim 1, wherein the step of setting the new transmission rate comprises the step of:
confirming a new transmission rate based upon the buffering information transmitted from the mobile terminal through a transmission rate assignment table and setting the confirmed new transmission rate,
wherein the moving picture mail server includes the transmission rate assignment table corresponding to the buffering information.

3. The method as set forth in claim 1, wherein the step of editing the moving picture mail according to the newly set transmission rate comprises the step of:
performing an editing operation by reducing a size of an image frame according to the newly set transmission rate so that image data can be reproduced in real time.

4. A method for enabling a mobile terminal to receive moving picture mail from a moving picture mail server, comprising the steps of:
(a) when the moving picture mail server notifies the mobile terminal that the moving picture mail has arrived, allowing the mobile terminal to request that the moving picture mail be transmitted;
(b) receiving the moving picture mail from the moving picture mail server, storing the received moving picture mail in a buffer, reproducing data of the received moving picture mail, and buffering other data of the received moving picture mail when an amount of data accumulated in the buffer has reached a predetermined size or more;
(c) allowing the mobile terminal to generate buffering information based upon the amount of data accumulated in the buffer at a predetermined time interval and to transmit the buffering information to the moving picture mail server; and
(d) repeatedly performing an operation for receiving moving picture mail from the moving picture mail server according to a newly set transmission rate based upon the buffering information, storing the moving picture mail in the buffer, and reproducing the moving picture mail.

5. The method as set forth in claim 4, wherein the step of generating the buffering information comprises the steps of:
checking the amount of data accumulated in the buffer at a predetermined time; and
determining the buffering information according to the amount of data accumulated in the buffer and transmitting the decided buffering information to the moving picture mail server.

6. A method for enabling a moving picture mail server to transmit, to a mobile terminal, moving picture mail in which image and audio signals are combined, comprising the steps of:
(a) allowing the moving picture mail server to transmit the moving picture mail at a preset transmission rate;
(b) allowing the mobile terminal to buffer received moving picture mail, to reproduce data of the received moving picture mail and to buffer other data of the received moving picture mail, when an amount of buffered data has reached a predetermined size or more;
(c) allowing the mobile terminal to generate buffering information based upon the amount of data buffered at a predetermined time interval and to transmit the buffering information to the moving picture mail server; and
(d) allowing the moving picture mail sever to set a new transmission rate based upon the buffering information from the mobile terminal, to edit the moving picture mail according to the newly set transmission rate, and to perform a transmission operation.

7. The method as set forth in claim 6, wherein the step of allowing the mobile terminal to generate the buffering information comprises the steps of:
checking the amount of data accumulated in the buffer at a predetermined time; and
determining the buffering information according to the amount of data accumulated in the buffer and transmitting the decided buffering information to the moving picture mail server.

8. The method as set forth in claim 6, wherein the step of setting the new transmission rate comprises the step of:
confirming a new transmission rate based upon the buffering information transmitted from the mobile terminal through a transmission rate assignment table and setting the confirmed new transmission rate,
wherein the moving picture mail server includes the transmission rate assignment table corresponding to the buffering information.

9. The method as set forth in claim 6, wherein the step of editing the moving picture mail according to the newly set transmission rate comprises the step of:
performing an editing operation by performing a decimation operation for an image frame according to the newly set transmission rate so that image data can be reproduced in real time.

10. An apparatus for enabling a mobile terminal to receive moving picture mail from a moving picture mail server, comprising:
a packet disassembler for removing packet headers from packets of the received moving picture mail and disassembling the packets;
a buffer for buffering the moving picture mail of the disassembled packets;
a controller for controlling an operation for outputting the moving picture mail and buffering the received moving picture mail when an amount of data accumulated in the buffer has reached a predetermined size or more, and generating buffering information based upon the amount of data accumulated in the buffer at a predetermined time interval, and transmitting the buffering information to the moving picture mail server;
an image codec for decoding a moving picture signal output from the buffer; and
a display unit for displaying the decoded moving picture signal output from the image codec.

11. An apparatus for enabling a mobile terminal to receive moving picture mail from a moving picture mail server, the moving picture mail being a signal in which image and audio signals are interlaced and combined, comprising:
a packet disassembler for removing packet headers from packets of the received moving picture mail and disassembling the packets;
a buffer for buffering the moving picture mail of the disassembled packets;
a controller for controlling an operation for outputting data of the received moving picture mail and buffering other data of the received moving picture mail when an amount of data accumulated in the buffer has reached a predetermined size or more, and generating buffering information based upon the amount of data accumulated in the buffer at a predetermined time interval, and transmitting the buffering information to the moving picture mail server;
a header analyzer for analyzing headers of the moving picture mail output from the buffer and generating a control signal necessary for separating the image and audio signals from the moving picture mail;
a splitter for separating the image and audio signals from the moving picture mail in response to the control signal;
an image codec for decoding the separated image signal output from the buffer;
a display unit for displaying a moving picture signal output from the image codec; and
an audio codec for decoding the separated audio signal.
